(19) United States
(12) Patent Application Publication
(10) Pub. No.: US 2002/0032732 A1
(43) Pub. Date: Mar. 14, 2002

(54) System for providing event information

(75) Inventor: Makoto Shigehara, Tokyo (JP)

Correspondence Address: Paul J. Esatto, Jr., Scully, Scott, Murphy & Presser, 400 Garden City Plaza, Garden City, NY, 11530, US

(73) Assignee: OLYMPUS OPTICAL CO., LTD, TOKYO (JP)

(21) Appl. No.: 09/902,406

(22) Filed: Jul. 10, 2001

(30) Foreign Application Priority Data
Jul. 14, 2000 (JP) 2000-215105

(51) Int. Cl. G06F 9/46; G06F 15/16

(52) U.S. Cl. 709/204; 709/318

(57) ABSTRACT

According to a system for providing event information of the present invention, a content provider photographs and records the lecture content and the like of lecture meetings on the basis of requests from users or its own judgment and posts the subjects, lecturers, date and hour of the obtained lecture meetings on its own home page over the Internet. When the user selects a lecture meeting the user wants and registers the user's mail address or the like, the user receives the delivery of photographed content and materials of lecture content and the like of the lecture meeting from the content provider. At that time, an advertisement is simultaneously delivered from an advertising server which the content provider individually contracts with, so that the user's monetary burden can be lightened.

This application claims benefit of Japanese Application No. 2000-215105 filed in Japan on Jul. 14, 2000, the contents of which are incorporated by this reference.

### BACKGROUND OF THE INVENTION

1. Field of the Invention

The present invention relates to a system for providing event information in a place of an event such as a lecture meeting or the like.

2. Related Art Statement

Hitherto, lecture meetings, academic meetings, expositions, and other events have been held in any place at any time. In various events, various information is provided in various form. In the normal lecture meeting, predetermined lectures are sequentially performed in one meeting place. Alternatively, in some cases, they are performed concurrently in a plurality of meeting places. In many cases, information such as subjects and the like of the lectures is previously submitted by an organizer or the like. A person, who wants to view and listen to a lecture, goes to a predetermined place (meeting place) at predetermined time on the basis of the announced information to view and listen to the lecture.

In many cases, most of lecture meetings and the like are carried out live and audiences are prohibited from recording speech and images. Unless the organizer records speech and images, the audiences cannot view and listen to the lecture again.

Furthermore, in many cases, important information different from that obtained in publications or the like is announced in the event such as a lecture meeting or the like. In these days of remarkable technical innovation, persons who desire to view and listen to lecture meetings are increased.

In a case where a person desires to view and listen to lecture meetings, academic meetings, expositions, and other events, for example, there are a plurality of lecture meetings and the like which the person desires to view and listen to, when the meetings are overlapped in terms of time or they are held in places away from each other, the person cannot view and listen to all of the lectures desired.

Since it is difficult for outside persons to know information other than that announced by the organizer, it is hard to further obtain information related to the lecture meeting regarding a predetermined subject.

Moreover, since the person who desires to view and listen to the lecture meeting must go to a predetermined place (meeting place) at predetermined time, the person is subjected to constraints in terms of time and places and economical loads are also put on the person. When the lecture meeting place is faraway, time and cost additionally mount, so that large constraints and economic burden are put on the person who desires to view and listen.

In addition, since most of the lecture meetings and the like are carried out live, it is impractical to repetitively view and listen to them as long as recording speech, images, and the like is not individually permitted.

On the other hand, it is possible to record various information related to the event on the organizer side or record the event through a third party making a contract with the organizer and, after that, provide the information to the desiring person. However, it is difficult to always grasp the date and hour, subjects, and the like of various lecture meetings held. In addition, a method for acquiring the recorded information and the like is not easily performed. It is inconvenient for the person who desires to view and listen.

### OBJECT AND SUMMARY OF THE INVENTION

It is an object of the present invention to provide a system for providing event information in which information related to a desired event can be properly obtained.

Specifically, the system for providing event information of the present invention includes:

event information obtaining means being capable of obtaining at least one event information in an event place;

request information receiving means for receiving at least one event information which an information user requests to obtain in the event place; and

event information providing means for, in response to the information user's request received by the request information receiving means, providing one or a plurality of event information among the event information obtained by the event information obtaining means to the information user through a signal transmission path.

This objects and advantages of the present invention will become further apparent from the following detailed explanation.

### BRIEF DESCRIPTION OF THE DRAWINGS

FIG. 1 is an explanatory diagram showing the outline of a system for providing event information according to a first embodiment of the present invention;

FIG. 2 is a flowchart explaining the operations of a content provider, a user, and an advertising server in the system for providing event information of the above first embodiment;

FIG. 3 is a flowchart showing an example of a case where the user requests the delivery of event content information to the content provider in the system for providing event information of the foregoing first embodiment;

FIG. 4 is an explanatory diagram showing an arrangement example of content information and an advertising screen delivered to the user in the system for providing event information of the foregoing first embodiment;

FIG. 5 is an explanatory diagram showing an arrangement example of the content information and the advertising screen delivered to the user in the system for providing event information of the foregoing first embodiment;

FIG. 6 is an explanatory diagram showing the outline of a system for providing event information according to a second embodiment of the present invention;

FIG. 7 is a flowchart explaining the operation of a content provider, a user, a user database in the system for providing event information of the above second embodiment;

FIG. 8 is a flowchart showing an example of a case where the user requests the delivery of event content information to the content provider in the system for providing event information of the above second embodiment;

FIG. 9 is an explanatory diagram showing the outline of a system for providing event information according to a third embodiment of the present invention;

FIG. 10 is a flowchart showing the operations of a content provider, a user, a user database in the system for providing event information of the above third embodiment;

FIG. 11 is an explanatory diagram showing the outline of a system for providing event information according to a fourth embodiment of the present invention; and

FIG. 12 is a flowchart explaining the operation of the system for providing event information of the above fourth embodiment.

### DETAILED DESCRIPTION OF THE PREFERRED EMBODIMENTS

Embodiments of the present invention will now be described hereinbelow with reference to the drawings.

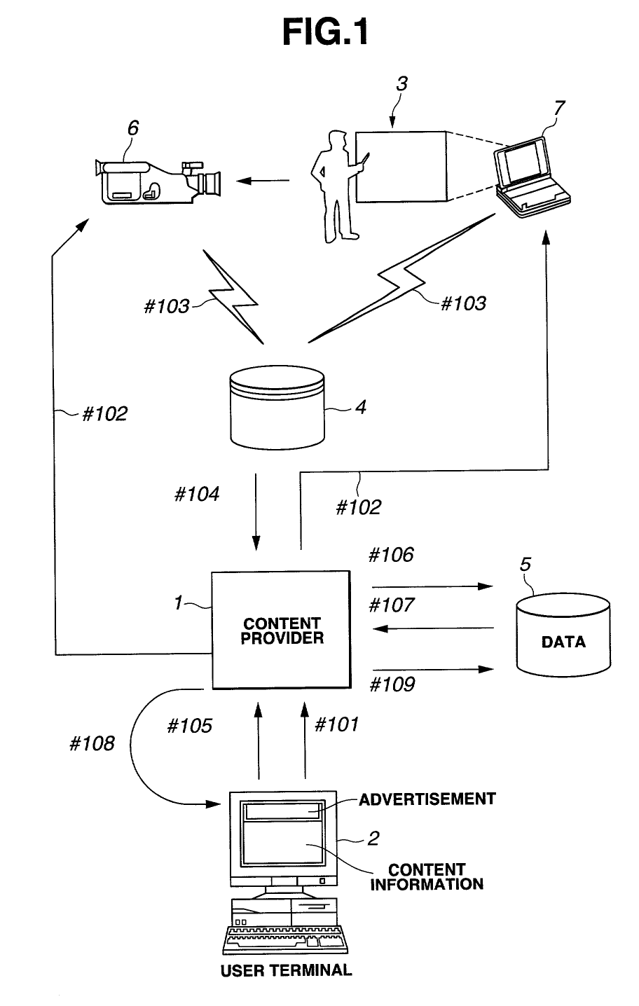

FIG. 1 is an explanatory diagram showing the outline of the system for providing event information according to a first embodiment of the present invention.

As an “event” in the system for providing event information of the present embodiment, an information source generating place such as lecture meeting, academic meeting, exposition, etc., where predetermined information is announced in a predetermined place at predetermined time (period), is assumed.

The system for providing event information according to the first embodiment is characterized in that an information provider, who obtains various information in an event and provides predetermined information among the information to a using person, previously obtains information related to an event which the information using person desires and information which the information provider predicts by itself, submits a plurality of obtained information to the information using person, and delivers the information selected by the information using person to the information using person.

As shown in FIG. 1, an information provider (hereinbelow, referred to as a content provider) 1 mentioned above is connected to the aggregation of networks, which have a common protocol and a common address format and which are connected to each other through signal transmission paths such as communication lines or the like: the so-called Internet. Mainly, the content provider 1 obtains predetermined information related to an event (assumed as a lecture meeting in the present embodiment) 3 and provides predetermined information among the information to a using person (hereinbelow, referred to a user) 2.

The content provider 1 has its own home page (HP) to be opened through the Internet, posts accompanying information such as subject, date and hour, etc. related to the event 3, and receives data such as a request or the like from the user 2.

The user 2 is shown as a user terminal in the diagram. The terminal can be connected to the Internet and comprises an information terminal device (for example, a personal computer) which can display predetermined content information related to the content provider 1 or advertising information distributed from an advertising server 5 (which will be described below) by executing predetermined browser-based software.

Although various information is considered as information related to a lecture meeting as the event 3, in the present embodiment, photographing information in the lecture meeting (specifically, image and speech information such as scenery and speech upon announcement), an announced lecture, announced materials, the profile of a lecturer, and other lectured content information, (hereinbelow, referred to as lecture direct information), and further, information accompanied with the lecture (for example, the lecture subject, name of the lecturer, date and hour of the lecture, lecture meeting place, etc.) are assumed.

Among the information, the photographing information such as scenery, speech, and the like upon announcement is photographed by a TV camera 6 under management of the content provider 1 (as a dealer). The information is converted into a predetermined format and is then stored into an information database 4.

The announced lecture, announced materials, profile of the lecturer, other lectured content information, and the accompanying information are stored into the information database 4 via networks by a data server (for example, a personal computer) 7 connected to the Internet under management of the organizer of the event 3. As means and method for storing the photographing information obtained by the TV camera 6 to the information database 4 and means and method for storing the information obtained by the personal computer 7 into the information database 4, well-known techniques are used. The detailed description is omitted here.

On the Internet, the information database 4 disposed under management of the content provider 1 exists. The information database 4 stores predetermined information related to the event 3 under management of the content provider 1.

Furthermore, on the Internet, the advertising server 5 exists, which delivers a predetermined advertising screen to a contracted user over the Internet. The advertising server 5 is a server for handling various advertising information. The advertising server 5 receives a delivery request from the content provider 1 and transmits predetermined advertising data to the content provider 1. When the delivery request is received from the content provider 1, the advertising server 5 receives personal information of the user 2, the information being grasped by the content provider 1, selects and prepares advertisement corresponding to the user 2, and transmits the advertisement to the content provider 1. On the basis of the number of times to deliver the advertisement to the user 2 by the content provider 1, the advertising server 5 is charged by the content provider 1.

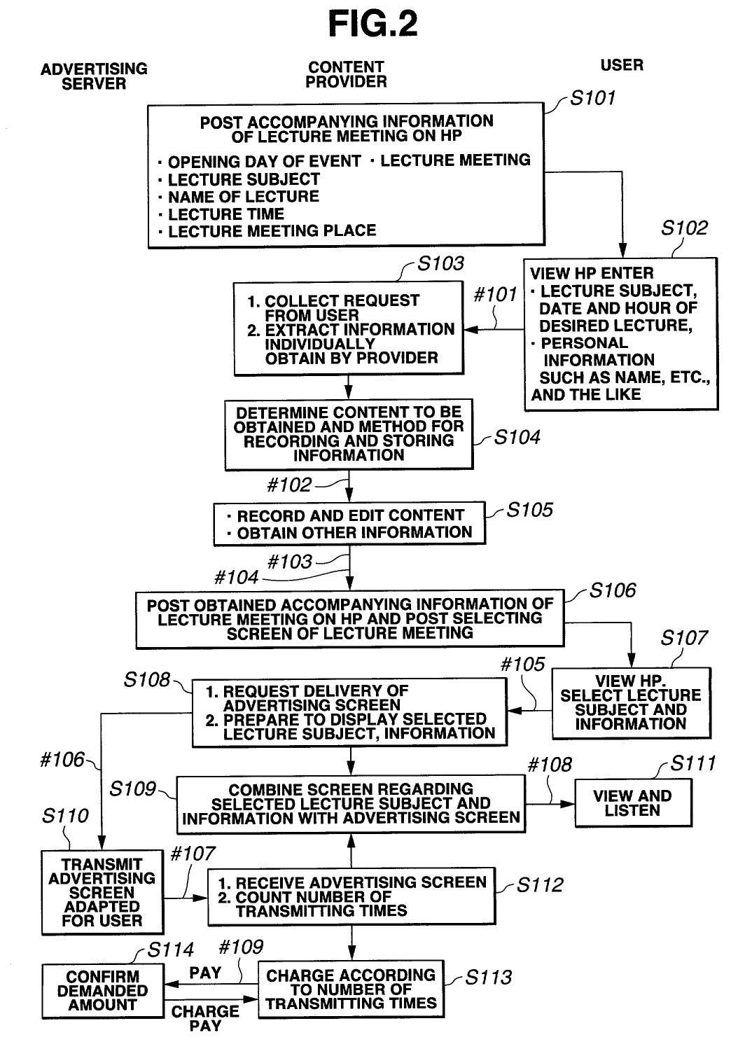

Subsequently, referring to FIG. 1 and a flowchart shown in FIG. 2, the operations of the content provider 1, user 2, and advertising server 5 will now be described. In FIG. 2, the middle flow indicates the operation of the content provider 1 (including the information database 4), the left flow denotes the operation of the advertising server 5, and the right flow indicates the operation of the user 2, respectively. Each step is designated by the step number. Furthermore, the operation performed between the elements, that is, between the content provider 1 and the user 2 or the like are designated by the number shown by #nnn different from the step number.

First, the content provider 1 posts accompanying information of a lecture meeting whose information has been previously provided from the event 3, for example, the lecture subject, name of a lecturer, date and hour of the lecture meeting, lecture meeting place, and the like on its own home page (HP) (step S101).

The user 2 views the home page of the content provider 1 by using predetermined browser software over the Internet to obtain the accompanying information of the lecture meeting (step S102). When there is a lecture meeting in which the user 2 desires to view and listen, the user 2 properly inputs data of items such as lecture subject, date and hour of the lecture meeting, name of the lecturer, etc. on the browser to request the content provider 1 to obtain the desired content (lecture direct information such as photographing information, lectured content information, or the like) (#101 in FIGS. 1 and 2). At that time, the user 2 inputs personal information such as address, name, telephone number, mail address, etc. and then transmits the information to the content provider 1.

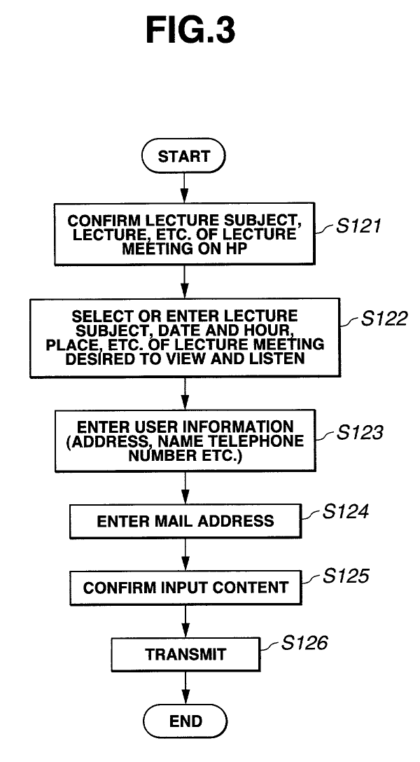

As to the process in step S102, #101 mentioned above, that is, the process in which the user 2 requests to the content provider 1 the content information of the event 3 that the user desires, a specific example will now be described with reference to a flowchart shown in FIG. 3.

FIG. 3 is a flowchart showing an example of a case where the user requests the delivery of event content information to the content provider in the system for providing event information of the present embodiment.

When the user 2 confirms accompanying information (the lecture subject, lecturer, and the like) of the event 3 (lecture meeting) on the home page of the content provider 1 over the Internet (step S121), the user selects or enters the subject, date and hour, place, and the like of the lecture meeting desired to be viewed and listened (step S122). Subsequently, the user 2 enters on the browser the user's personal information such as address, name, telephone number, etc. (step S123), and further, enters the user's mail address (step S124). After that, the user 2 confirms the input content (step S125) and then transmits the data to the content provider 1 (step S126).

A plurality of users can simultaneously view the home page of the content provider 1. As for the request from the user in #101 as well, the content provider 1 can receive requests from a plurality of users.

The content provider 1 receives the requests from the users 2 (#101) and collects content information which the users (assuming that a plurality of users exist) desire. The content provider 1 extracts content (lecture direct information such.as photographing information, lectured content information, or the like) related to the event 3 desired to individually obtain (step S103). The content provider 1 determines content to be obtained on the basis of the collection and extraction results and determines a method for recording and storing the content information (step S104), and instructs a predetermined authority to obtain the content by the predetermined recording and storing method (#102).

The instructed predetermined authority records the content information of the event 3 and provides the lectured content information to the content provider 1 (step 105). The various information are stored into the information database 4 under management of the content provider 1 (#103).

As a method for recording and storing the content of the event 3 through the instructed predetermined authority, the following method is assumed in the system for providing event information of the present embodiment.

As to the photographing information of the event 3, a dealer requested from an administrator of the content provider 1 or the administrator of the content provider 1 itself photographs the event 3 with the TV camera 6 or the like to obtain necessary content information. The information is properly subjected to edition, format conversion, and the like and, after that, the information is stored into the information database 4.

As for the lectured content information of the event 3, the content provider 1 accesses the data server (for example, the personal computer) 7 under management of the organizer of the event 3 over the Internet or the like, obtains necessary information from the data server via the network, and stores the information into the information database 4.

The content information of the event 3 stored in the information database 4 is transmitted to the content provider 1 (#104). The content provider 1 properly posts accompanying information related to the obtained content on its own home page (step S106). In other words, information accompanied with the content information of the event 3, which is obtained from the collection result based on the desire from the user 2 (when there are desires from a plurality of users, the respective desires are properly processed) and the extraction result by the content provider 1 itself, is posted on the home page.

The user 2 views the home page of the content provider 1 over the Internet with the predetermined browser software to obtain accompanying information (the subject, lecturer, and the like of the lecture meeting) of the lecture meeting acquired by the content provider 1 (step S107). When there is a desired lecture meeting, that it, when the user desires the delivery of content related to the lecture, the user properly inputs data of predetermined items on the browser and selects the content desired to deliver to request the delivery of the content provider 1 (step S107, #105).

The process in step S107, #105, that is, the process in which the user 2 requests the delivery of the content information of the event 3 desired by the user 2 is also performed according to the flowchart shown in FIG. 3.

In other words, when the user 2 confirms the lecture subject, lecturer, and the like of the event 3 (lecture meeting) prepared by the content provider 1 on the home page of the content provider 1 over the Internet (step S121), the user 2 selects or enters the subject, date and hour, place, and the like of the lecture meeting desired to be viewed and listened (step S122). Subsequently, the user 2 enters the personal information of the user, e.g., address, name, telephone number, and the like on the browser (step S123) and also enters their mail address (step S124). After that, the user 2 confirms the input content (step S125) and then transmits the data to the content provider 1 (step S126). Due to the transmitting operation, the user 2 requests the delivery of the content information related to the predetermined event 3 (lecture meeting) to the content provider 1.

Referring once again to FIG. 2, when the content provider 1 is requested by the user 2 to deliver the content information (#105), the content provider 1 transmits the personal information concerned with the user 2 to the advertising server 5 and also requests the delivery of an advertising screen (step S108). Furthermore, the content provider 1 receives the delivery request of the content information from the user 2 to prepare to display the content information related to the selected lecture (step S108).

When the advertising server 5 receives the personal information concerned with the user 2 and also receives the delivery request of the advertising screen (#106), the advertising server 5 prepares the advertising screen corresponding to each user 2 on the basis of the received personal information of the user 2 and transmits data of the screen to the content provider 1 (step S110, #107).

When the content provider 1 receives the advertising screen data from the advertising server 5 (#107), the content provider 1 counts the number of times to transmit the advertising screen to the users 2 in order to charge the advertising server 5 (step S112).

The content provider 1 combines a display screen related to the content information prepared in step S108 mentioned above with the advertising screen prepared in step S110 mentioned above in a predetermined image process (step S109) and then delivers the content information and advertising screen to the user 2 over the Internet (#108).

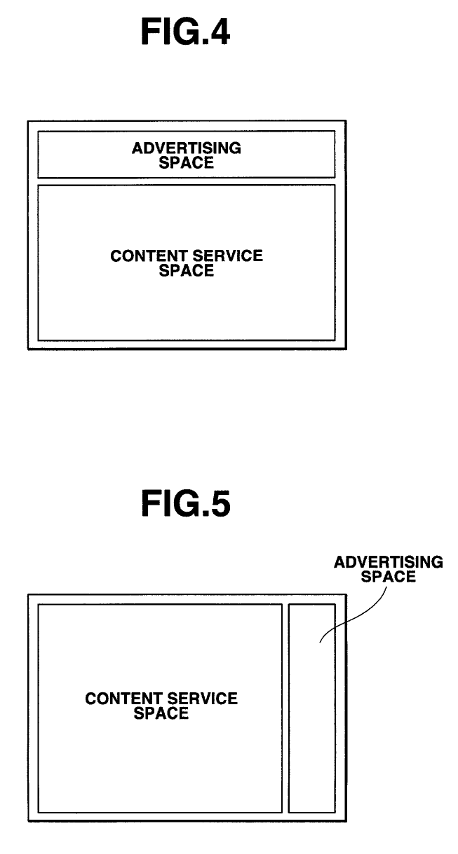

FIGS. 4 and 5 are explanatory diagrams showing arrangement examples of the content information and the advertising screen to be delivered to the user 2.

The user 2 receives the content information and the advertising screen from the content provider 1 over the Internet to view and listen the desired content information (step S111).

On the other hand, the content provider 1 charges the advertising server 5 according to the number of times to transmit the advertising screen, which was counted in step S112 mentioned above (step S113, #109).

As to such a payment demand (#109) from the content provider 1, the advertising server 5 confirms the demand and then pays a predetermined fee (step S114).

As mentioned above, according to the system for providing event information of the present embodiment, the system for providing event information, in which the user 2 can obtain information related to an event (lecture meeting) desired by the user 2 at any time any number of times without charge, can be provided.

The system for providing event information according to a second embodiment of the present invention will now be described.

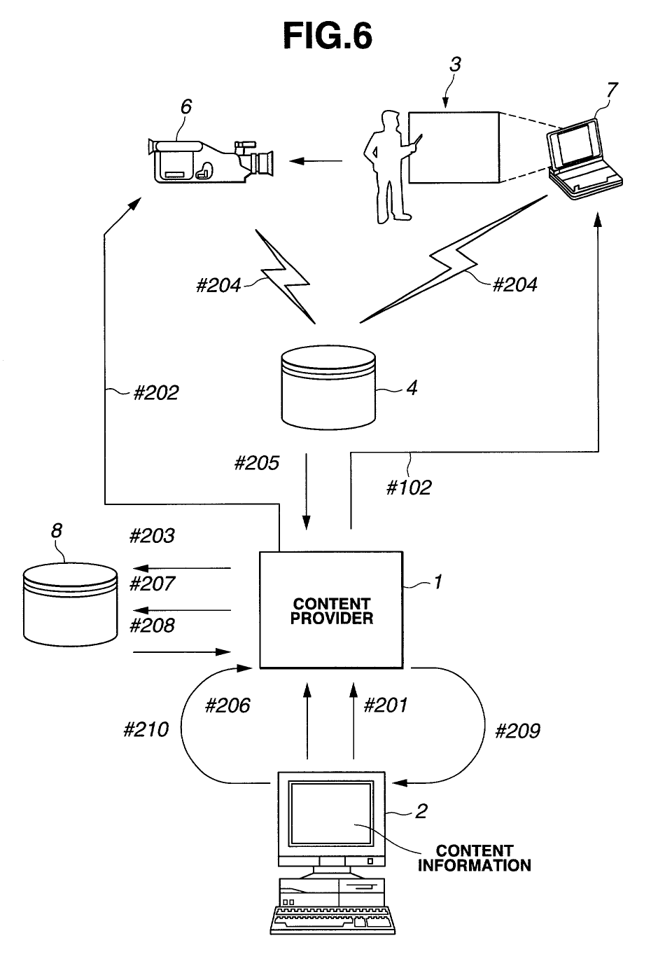

FIG. 6 is an explanatory diagram showing the content of the system for providing event information according to the second embodiment of the present invention. In the diagram, the same components as those in the first embodiment are designated by the same reference numerals and the detailed description is omitted here to avoid overlaps.

According to the second embodiment, the system for providing event information is characterized in that an information provider, who obtains various information regarding an event and provides predetermined information among the information to a user, acquires in advance information related to an event which an information user desires and information which the information provider predicts by itself, submits the plurality of acquired information to the information user, and charges the information user for the information selected by the information user to deliver the information.

As shown in FIG. 6, the content provider 1 is connected to the so-called Internet in the same way as the above first embodiment, and mainly obtains predetermined information related to the event 3 and provides predetermined information among the information to the user 2.

The content provider 1 has its own home page to be opened on the Internet, posts accompanying information such as subject, date and hour, and the like related to the event 3, and receives data such as a request or the like from the user 2.

The user 2 appears as a user terminal in the diagram. The terminal can be connected to the Internet and comprises an information terminal device (for example, a personal computer) which can display predetermined content information related to the content provider 1 by executing predetermined browser-based software.

In the present embodiment as well, a lecture meeting or the like is assumed as the event 3. As information related to the lecture meeting, photographing information in the lecture meeting (specifically, image and voice information such as scenery and speech upon announcement), a lecture manuscript, lecture materials, the profile of a lecturer, and other lectured content information, (hereinbelow, referred to as lecture direct information), and further, information accompanied with the lecture (for example, the lecture subject, name of the lecturer, date and hour of the lecture, lecture meeting place, etc.) are assumed.

Among the information, the photographing information such as scenery, speech, and the like upon announcement is photographed by the TV camera 6 under management of the content provider 1 (as a dealer). The information is converted into a predetermined format and is then stored into the information database 4.

The lecture manuscript, lecture materials, profile of the lecturer, other lectured content information, and the accompanying information are stored into the information database 4 via networks by the data server (e.g., the personal computer) 7 connected to the Internet under management of the organizer of the event 3. As means and method for storing the photographing information obtained by the TV camera 6 to the information database 4 and means and method for storing the information obtained by the personal computer 7 into the information database 4, well-known techniques are used. The detailed description is omitted here.

On the Internet, the information database 4 disposed under management of the content provider 1 exists. The information database 4 stored predetermined information related to the event 3 under management of the content provider 1.

Moreover, on the Internet, a user database 8 arranged under management of the content provider 1 exists. The user database 8 is a server for handling personal information of the user 2 making an agreement with the content provider 1. The user database 8 receives and registers the information of the user 2 from the content provider 1, and confirms a payment method for the user 2 and the like.

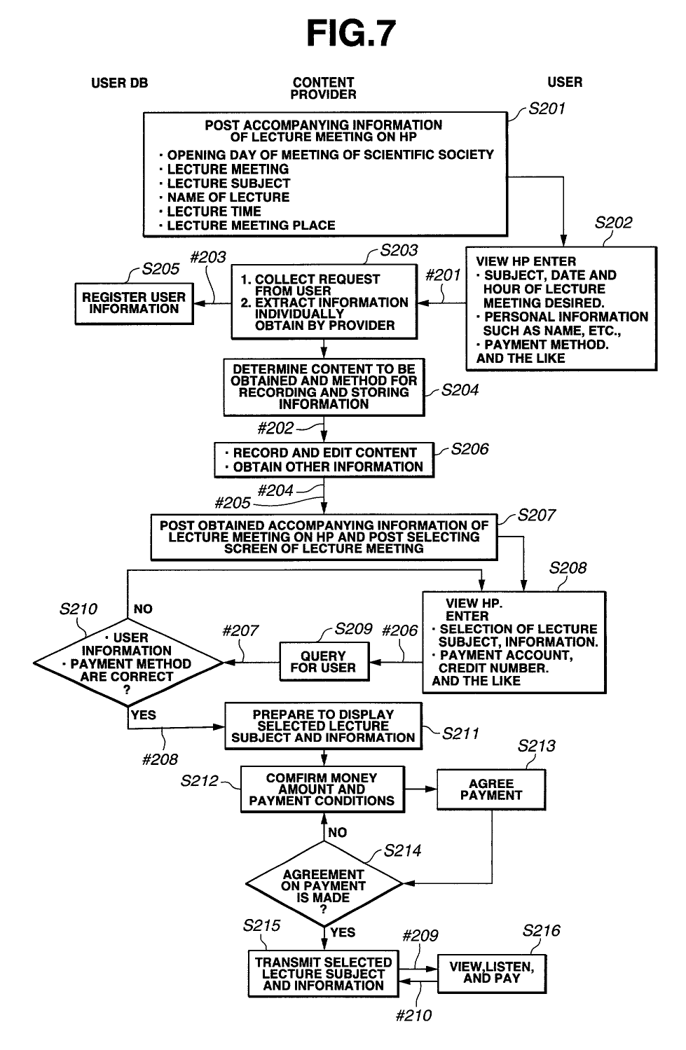

Referring to FIG. 6 and a flowchart shown in FIG. 7, the operations of the content provider 1, user 2, and user database 8 will now be described. In FIG. 7, the middle flow indicates the operation of the content provider 1 (including the information database 4), the left flow denotes the operation of the user database 8, and the right flow indicates the operation of the user 2. Each step is designated by the step number. Furthermore, the operation performed between the elements, that is, between the content provider 1 and the user 2 or the like are designated by the number shown by #nnn different from the step number.

First, the content provider 1 posts accompanying information of a lecture meeting whose information has been previously provided from the event 3, for example, the lecture subject, name of a lecturer, date and hour of the lecture meeting, a lecture meeting place, and the like on its own home page (HP) (step S201).

The user 2 views the home page of the content provider 1 over the Internet with predetermined browser software to obtain the accompanying information of the lecture meeting (step S202). When there is a lecture in which the user 2 desires to view and listen, the user 2 properly inputs data of items of the lecture subject, date and hour of the lecture meeting, name of the lecturer, and the like on the browser to request the content provider 1 to acquire the desired content (lecture direct information such as photographing information, lectured content information, and the like) (#201 in FIGS. 6 and 7). At that time, the user 2 inputs personal information, e.g., address, name, telephone number, mail address, a method for paying a fee to obtain information, and the like, and then transmits the information to the content provider 1.

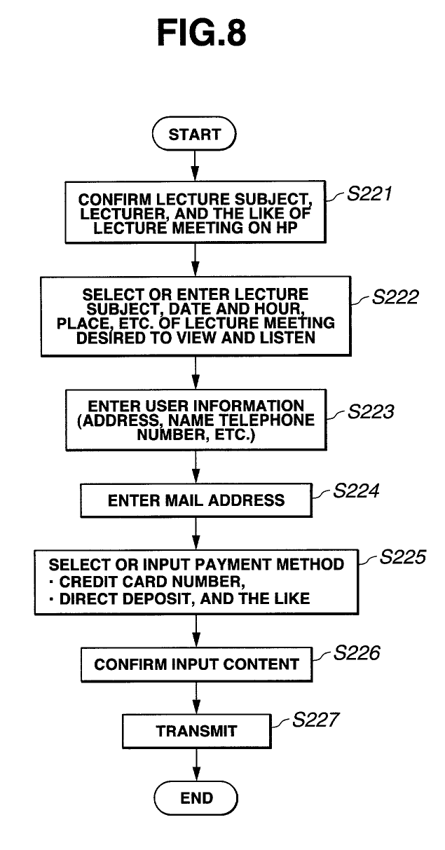

As to the process in step S202, #201 mentioned above, that is, the process in which the user 2 requests the content information of the event 3, which the user 2 desires, to the content provider 1, a specific example will now be described with reference to a flowchart shown in FIG. 8.

FIG. 8 is a flowchart showing an example of a case where the user requests the delivery of event content information to the content provider in the system for providing event information of the present embodiment.

When the user 2 confirms accompanying information (the subject of a lecture meeting, a lecturer, and the like) of the event 3 (lecture meeting) on the home page of the content provider 1 over the Internet (step S221), the user 2 selects or enters the subject, date and hour, place, and the like of the lecture meeting, in which the user 2 desires to view and listen (step S222). Subsequently, the user 2 enters the user's personal information such as address, name, telephone number, and the like on the browser (step S223), and further, enters their mail address (step S224). Furthermore, the user 2 inputs a method for paying a fee to obtain information (step S225) and then confirms the input content (step S226). After that, the user 2 transmits the data to the content provider 1 (step S227).

A plurality of users can simultaneously view the home page of the content provider 1. As for the request from the user in #201 mentioned above, the content provider 1 can receive requests from a plurality of users.

The content provider 1 receives the requests from the users 2 (#201) and collects content information the users (assuming that a plurality of users exist) desire. The content provider 1 extracts content (lecture direct information such as photographing information, lectured content information, and the like) related to the event 3, which is preferably individually obtained (step S203). The content provider 1 determines content to be obtained on the basis of the collection and extraction results and determines a method for recording and storing the content information (step S204), and instructs a predetermined authority to obtain the content by the determined recording and storing method (#202).

On the other hand, the content provider 1 transmits the user's personal information such as address, name, telephone number, mail address, a method for paying a fee, and the like to the user database 8 (#203). The user database 8 registers the information (step S205).

After step S204 mentioned above, the instructed predetermined authority records the content information of the event 3 and provides lectured content information to the content provider 1 (step S206). A plurality of items of information are stored into the information database 4 under management of the content provider 1 (#204).

As a method for recording and storing the content of the event 3 through the instructed predetermined authority, the following method is assumed in the system for providing event information of the present embodiment.

As to the photographing information of the event 3, a dealer requested from the administrator of the content provider 1 or the administrator of the content provider 1 itself photographs the event 3 with the TV camera 6 or the like to obtain necessary content information. The information is properly subjected to edition, format conversion, and the like and is then stored into the information database 4.

As for the lectured content information of the event 3, the content provider 1 accesses the data server (for example, the personal computer) 7 disposed under management of the organizer of the event 3 over the Internet or the like, obtains necessary information from the data server via the network, and stores the information into the information database 4.

The content information of the event 3 stored in the information database 4 is transmitted to the content provider 1 (#205). The content provider 1 properly posts accompanying information related to the obtained content on its own home page (step S207). In other words, information accompanied with the content information of the event 3, which is obtained from the collection result based on the request from the user 2 (when there are requests from a plurality of users, the respective requests are properly processed) and the extraction result by the content provider 1 itself, is posted on the home page.

The user 2 views the home page of the content provider 1 on the Internet with the predetermined browser software to obtain accompanying information (the lecture subject, lecturer, and the like) of the lecture meeting acquired by the content provider 1 (step S208). When there is a desired lecture meeting, that it, when the user 2 desires the delivery of the content related to the lecture, the user 2 properly enters data of predetermined items on the browser, selects the content desired to deliver, and requests the delivery to the content provider 1 (step S208, #206).

The process in step S208, #206, that is, the process in which the user 2 requests the delivery of the content information of the desired event 3 to the content provider 1 is also performed according to the flowchart shown in FIG. 8.

In other words, when the user 2 confirms the lecture subject, lecturer, and the like of the event 3 (lecture meeting) prepared by the content provider 1 on the home page of the content provider 1 over the Internet (step S221), the user 2 selects or enters the subject, date and hour, place, and the like of the lecture meeting desired to be viewed and listened (step S222). Subsequently, the user 2 enters the user's personal information such as address, name, telephone number, etc. on the browser (step S223) and also enters their mail address (step S224). Moreover, the user 2 enters a payment method of a fee charged to obtain information (step S225), confirms the input content (step S226), and then transmits the data to the content provider 1 (step S227). The transmitting operation accomplishes a process in which the user 2 requests the delivery (chargeable) of the content information related to the predetermined event 3 (lecture meeting) to the content provider 1.

Referring once again to FIG. 7, when the delivery of the content information is requested from the user 2 (#206), the content provider 1 queries the user database 8 for the user 2 (step S209, #207).

When the query for the user 2 is made from the content provider 1, the user database 8 determines the suitability of the personal information of the user 2 and whether the fee payment method is proper (step S210). When it is incorrect, the user database 8 urges the user 2 to reenter.

In step S210, when confirming that the personal information of the user 2, the payment method, and the like have been correctly inputted (#208), the contents provider 1 displays the subject and the like of the lecture meeting selected by the user 2 on the home page (step S211) and confirms the money amount and payment conditions of the charge to the user 2 (step S212).

The user 2 confirms the finally selected items, money amount, payment conditions, and the like shown on the home page of the content provider 1 and then agrees the content (step S213).

The content provider 1 receives the agreement on payment by the user 2 (step S214) and delivers the content information related to the event 3 (lecture meeting) requested to be delivered by the user 2 (step S215, #209). The user 2 views delivered images and pays the fee according to the predetermined method (step S216, #210).

According to the system for providing event information of the present embodiment, the system for providing event information, in which information related to the event (lecture meeting) desired by the user 2 can be obtained at any time any number of times for a small fee, can be provided.

The system for providing event information according to a third embodiment of the present invention will now be described.

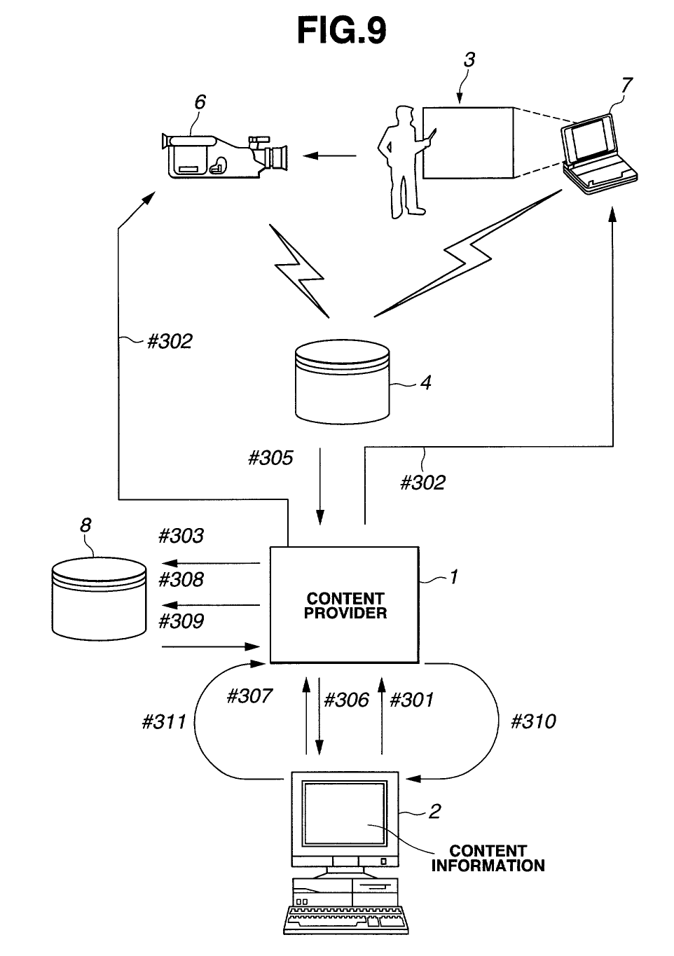

FIG. 9 is an explanatory diagram showing the outline of the system for providing event information as a third embodiment of the present invention. The same components as those in the foregoing first and second embodiments are designated by the same reference numerals and the detailed description is omitted to avoid overlaps.

As compared with the system for providing event information of the above second embodiment, the system for providing event information of the third embodiment is characterized in that when the content provider 1 posts accompanying information related to the event 3, which is obtained because the request is received from the user 2, on its own home page, the content provider 1 simultaneously informs the user 2 of the fact with an electronic mail. Accordingly, the other configuration and operation are the same as those of the second embodiment. A difference between both the embodiments will now be described here.

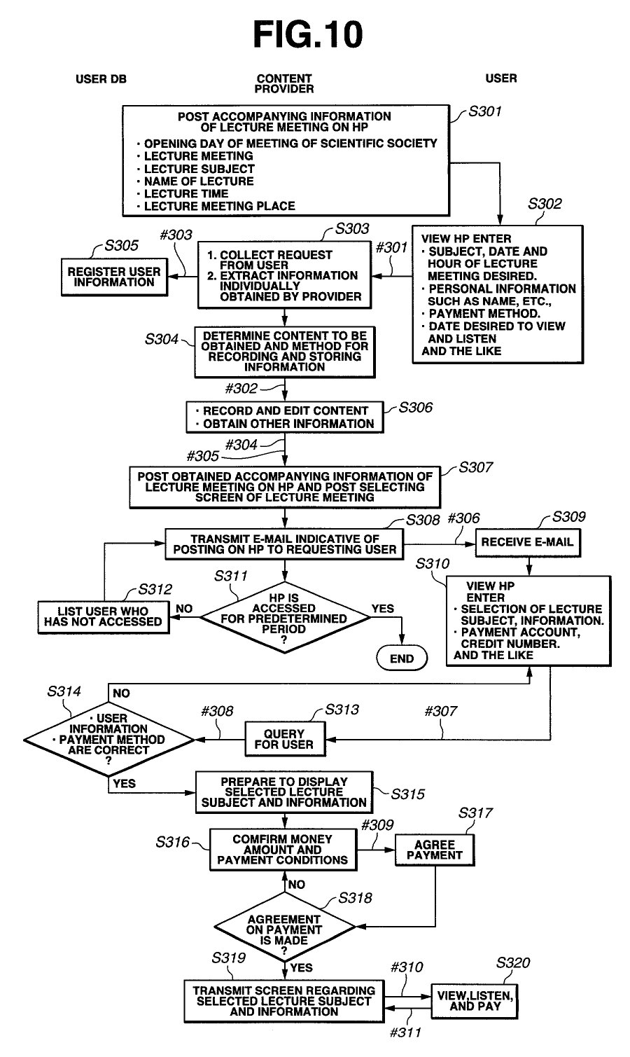

FIG. 10 is a flowchart showing the operations of the content provider 1, user 2, and user database 8 of the system for providing event information according to the third embodiment. Steps S301 to S307 and steps S313 to S320 are the same as steps S201 to S207 and steps S209 to S216 in FIG. 7 of the foregoing second embodiment. The operations shown by reference numerals #301 to #305 in FIGS. 9 and 10 correspond to those shown by reference numerals #201 to #205 in FIGS. 6 and 7. The operations shown by reference numerals #307 to #311 correspond to those shown by reference numerals #206 to #210 in FIGS. 6 and 7.

The operation, in which when the content provider 1 posts accompanying information related to the event 3 obtained on the basis of the request from the user 2 on its home page, the content provider 1 simultaneously informs the user 2 of the fact with an electronic mail, will be described hereinbelow with reference to FIGS. 10 and 9.

When the content provider 1 receives the request from the user 2 (step S302, #301), obtains accompanying information related to the event 3 (step S306), and posts the information on the home page of the content provider 1 in step S307, the content provider 1 informs the user 2 of the fact that the information is posted (step S308) with an electronic mail. The user 2 receives the electronic mail (#306), so that the user 2 can know that the content provider 1 has obtained the information related to the event 3 requested by the user (step S309).

Consequently, the user 2 views the home page of the content provider 1 on the Internet with the predetermined browser software, thereby obtaining accompanying information (subject, lecturer, and the like of the lecture meeting) of the lecture meeting obtained by the content provider 1 (step S310). When there is a desired lecture, that is, when the user 2 desires the delivery of content related to the lecture, the user 2 properly enters data of predetermined items on the browser, selects the content desired to deliver, and requests the delivery to the content provider 1 (step S310). The subsequent steps are the same as those of the second embodiment.

On the other hand, after the content provider 1 contacts the user 2 with the electronic mail in step S308, the content provider 1 monitors whether the relevant user 2 accesses the home page for a predetermined period (step S311). When there is no access from the user 2 for the predetermined period, the content provider 1 lists the user, who has not accessed, through the user database 8 (step S312) and again informs the user 2 of the fact that the information has been obtained with the electronic mail.

As mentioned above, according to the system for providing event information of the third embodiment, in addition to the advantages of the foregoing second embodiment, the fact that information has been obtained can be promptly informed exactly to the user 2, the opportunity to view and listen to information of the event 3 as early as possible can be given to the user 2, and the opportunity to more certainly acquire incoming can be given to the content provider 1.

The system for providing event information according to a fourth embodiment of the present invention will now be described.

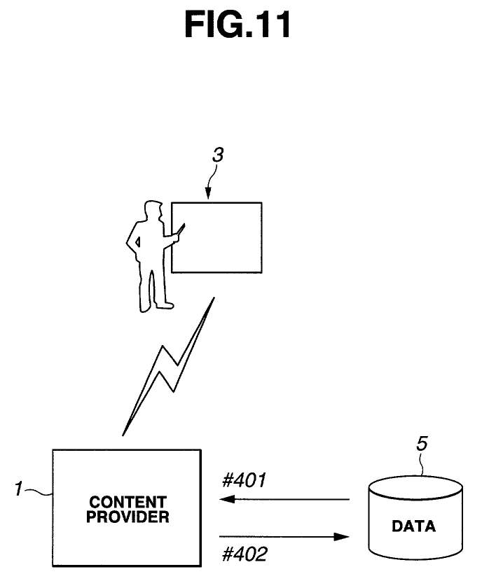

FIG. 11 is an explanatory diagram showing the outline of the system for providing event information as the fourth embodiment of the present invention. In the diagram, the same components as those in the foregoing first embodiment are designated by the same reference numerals and the detailed description is omitted to avoid overlaps.

The system for providing event information according to the fourth embodiment is another application example of the system for providing event information with the same configuration as that of the foregoing first embodiment and is characterized in that a personal computer terminal assumed as the user 2 is arranged in a place of the event 3 and predetermined information is provided to participants who visit the event 3.

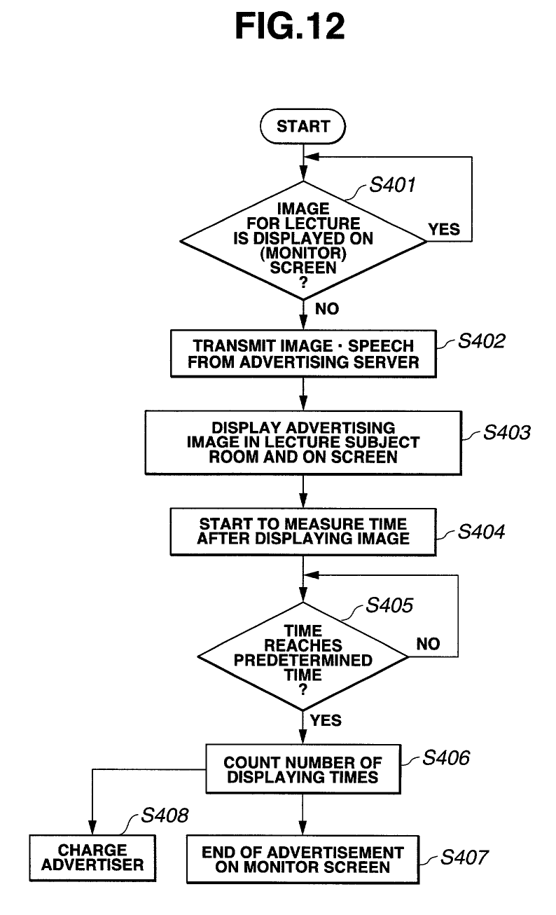

The operation of the present embodiment will now be described hereinbelow with reference to a flowchart shown in FIG. 12.

The content provider 1 obtains image information obtained by photographing the situation of the event 3 (lecture meeting) and provides the image information to the user 2 (in the present embodiment, a monitor screen disposed in each place of the event 3). When the image information is not displayed on the monitor screen (step S401), predetermined advertising information is delivered from the advertising server 5 (step S402, #401). Since the monitor screen displays nothing at that time, predetermined advertising images are displayed on the whole screen (step S403).

The content provider 1 measures displaying time of the advertising images (step S404). When the displaying time reaches predetermined time previously contracted between the content provider 1 and an advertiser (step S405), the content provider 1 counts the number of displaying times (step S406), finishes the advertisement on the monitor screen (step S407), and charges the advertiser (step S408).

In this invention, it is apparent that working modes different in a wide range can be formed on this basis of this invention without departing from the spirit and scope of the invention. This invention is not restricted by any specific embodiment except being limited by the appended claims.

What is claimed is:

1. A system for providing event information comprising:
event information obtaining means being capable of obtaining at least one event information in an event place;
request information receiving means for receiving at least one event information which an information user requests to obtain in the event place; and
event information providing means for, in response to a request from the information user received by the request information receiving means, providing one or a plurality of event information among the information obtained by the event information obtaining means to the information user through a signal transmission path.

2. A method for providing event information comprising:
an event information obtaining step of obtaining at least one event information in an event place;
a request information receiving step of receiving at least one event information which an information user requests to obtain in the event place; and
an event information providing step of, in response to a request from the information user received in the request information receiving step, providing one or a plurality of event information among the information obtained by the event information obtaining means to the information user through a signal transmission path.

3. A system for providing event information comprising:
requested information receiving means for receiving event information which an information user requests to obtain in an event place;
event information obtaining means for, in response to a reception result of the request information receiving means, obtaining event information according to a request from the information user in the event place; and
event information providing means for providing the event information obtained by the event information obtaining means to the information user through a signal transmission path.

4. A method for providing event information comprising:
a request information receiving step of receiving event information which an information user requests to obtain in an event place;
an event information obtaining step of, in response to a reception result of the request information receiving step, obtaining event information according to a request from the information user in the event place; and
an event information providing step of providing the event information obtained in the event information obtaining step to the information user through a signal transmission path.

5. A system for providing event information comprising:
information acquiring means for acquiring a plurality of information; and
information delivering means for delivering information, which a user selects from among the plurality of information obtained by the information acquiring means, to the user.

6. A system for providing event information comprising:
information acquiring means for acquiring a plurality of information;
desire receiving means for receiving a desire of a user; and
information delivering means for delivering information, which is related to the user's desired selection received by the desire receiving means, to the user.

7. The system for providing event information according to claim 6, wherein the information includes information acquired on the basis of the desire received from the user before the opening of an event and information acquired on the basis of the judgment of a content provider.

8. The system for providing event information according to claim 6, further comprising user desire acquiring means for receiving a desire of acquisition from the user before the opening of an event.

9. The system for providing event information according to claim 6, further comprising disclosure information selecting means being capable of selecting information the user desires disclose.

10. The system for providing event information according to claim 6, wherein the information relates to an event.

11. The system for providing event information according to claim 6, wherein the information is concerned with medical treatments.

12. The system for providing event information according to claim 7, wherein the event relates to a lecture meeting, an academic meeting, or an exposition.

13. A method for providing event information comprising:
an information acquiring step of acquiring a plurality of information; and
an information delivering step of delivering information, which a user selects from among the plurality of information acquired in the information acquiring step, to the user.

14. A method for providing event information comprising:
an information acquiring step of acquiring a plurality of information;
a desire receiving step of receiving a desire of a user; and
an information delivering step of delivering information, which is related to the user's desired selection received in the desire receiving step, to the user.

15. The event information providing method according to claim 14, wherein the information includes information acquired on the basis of the desire received from the user before the opening of an event and information acquired on the basis of the judgment of a content provider.

16. The event information providing method according to claim 14, further comprising a user desire acquiring step of receiving a desire of acquisition from the user before the opening of an event.

17. The event information providing method according to claim 14, further comprising a disclosure information selecting step being capable of selecting information which the user desires to disclose.

18. The event information providing method according to claim 14, wherein the information relates to an event.

19. The event information providing method according to claim 14, wherein the information is concerned with medical treatments.

20. The event information providing method according to claim 15, wherein the event relates to a lecture meeting, an academic meeting, or an exposition.
